(19) United States
(12) Patent Application Publication
(10) Pub. No.: US 2016/0354877 A1
(43) Pub. Date: Dec. 8, 2016

(54) METHOD FOR MAKING BICYCLE FOLDING TOOL

(71) Applicant: Tuo-Jen Chen, Taichung City (TW)

(72) Inventor: Tuo-Jen Chen, Taichung City (TW)

(21) Appl. No.: 14/730,252

(22) Filed: Jun. 4, 2015

(51) Int. Cl. B23P 15/00; B25F 1/04; B25B 15/00

(52) U.S. Cl. CPC B23P 15/00; B25B 15/001; B25F 1/04

(57) ABSTRACT

A method for making a bicycle folding tool includes a step of preparing: preparing a solid bar which has a hexagonal cross section, a rectangular cross section or a circular cross section; a step of cutting and forming a hole: cutting the bar into sections of pre-set length to form a semi-finished tool, a hole being simultaneously formed in one end of the section; a step of forming a working end: forming a working end to the semi-finished product by peeling and milling, and a step of forming a connection end: forming a connection end with the hole located at the center of the connection end to form the folding tool.

### BACKGROUND OF THE INVENTION

1. Fields of the Invention

The present invention relates to a method for making a bicycle folding tool.

2. Descriptions of Related Art

The conventional method for making a bicycle folding tool is disclosed in FIG. 1 and comprises a folding tool 14 which has a working end 12 and a connection end 13, wherein a hole 131 is defined through the connection end 13. The steps for making the conventional folding tool are as follows:

a step of preparing: preparing a bar 1 which is a solid bar and has a hexagonal cross section, a rectangular cross section and a circular cross section as shown in FIG. 2;

a step of cutting: cutting the bar 1 into sections with a pre-set length to form a base 10 as shown in FIG. 3;

a step of trimming: trimming tow ends faces of the base 10 to form a semi-finished product 11 as shown in FIG. 3;

a step of lathing: lathing the base 10 to form a working end 12 as shown in FIG. 4;

a step of forming the connection end: lathing or milling the other end of the bar to form the connection end 13, and removing surplus material on the connection end 13 as shown in FIG. 5, and

a step of forming the connection hole: forming a hole 131 through the connection end 13 by drilling or milling so as to form the folding tool 14 as shown in FIG. 6.

As shown in FIG. 7, although two flat faces 10A are formed on the two ends of the base 10, uneven portion 10B is formed at the underside of the base 10. The uneven portion 10B affects the clamping action of a clamping tool 15, and causes an incorrect outer size as shown in FIG. 8. Extra labor hours are needed to correct the problem. As shown in FIG. 9, especially in a mass production, the two end surfaces 12A, 13A of the base 10 are not vertical. Extra labor hours are needed to make the vertical surfaces 12A, 13A to be vertical to the horizontal. The end surface 12A is formed on the working end 12, and the end surface 13A is formed on the connection end 13, these two end surfaces 12A, 13A are required to be vertical and are used as a standard, so that even a limited tolerance to the two end surfaces 12A, 13A will affect the production of the folding tools 14. As shown in FIG. 10, because the cutting, trimming and forming the connection end are made on different working stations, so that the semi-finished product is clamped or positioned by different clamping tools, so that the distance X from the center of the hole 131 to the working end 12, and the distance Y from the center of the hole 131 to the connection end 13 will have accumulated tolerances, therefore, the folding tools 14 have a difference T between two folding tools 14. The folding tools 14 have different lengths which are deemed as unqualified products. Besides, because the end surfaces are needed to be trimmed, more material will be wasted.

The present invention intends to provide a method for making a bicycle folding tool so as to improve the shortcomings mentioned above.

### SUMMARY OF THE INVENTION

The present invention relates to a method for making a bicycle folding tool, and comprises:

a step of preparing: preparing a solid bar which has a hexagonal cross section, a rectangular cross section or a circular cross section;

a step of cutting and forming a hole: cutting the bar into sections of pre-set length to form a semi-finished tool, a hole being simultaneously formed in one end of the section;

a step of forming a working end: forming a working end to the semi-finished product by peeling and milling, and

a step of forming a connection end: forming a connection end with the hole located at the center of the connection end to form the folding tool.

Preferably, the step of cutting and forming a hole and the step of forming a connection end are operated simultaneously.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a conventional folding tool;

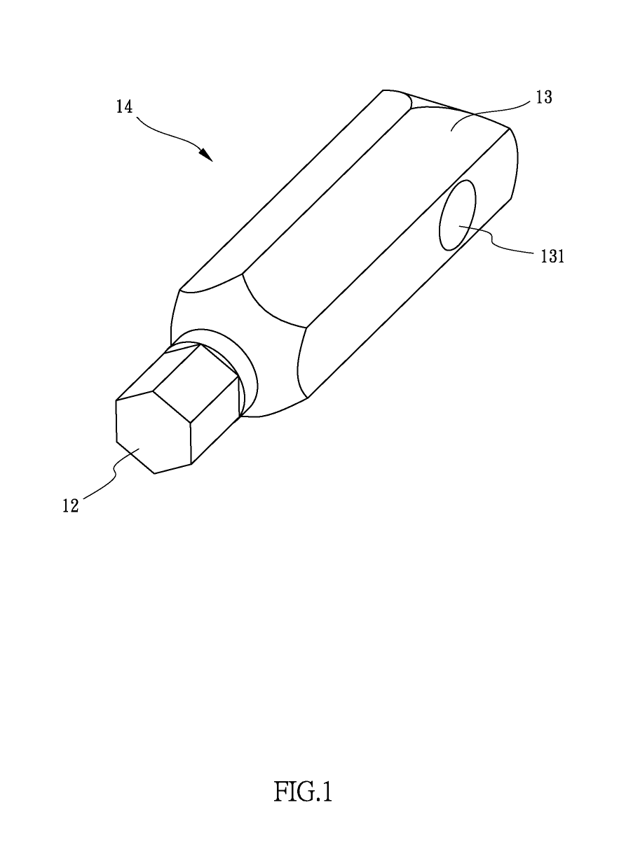

FIG. 2 shows the first step of the conventional method for making the conventional folding tool;

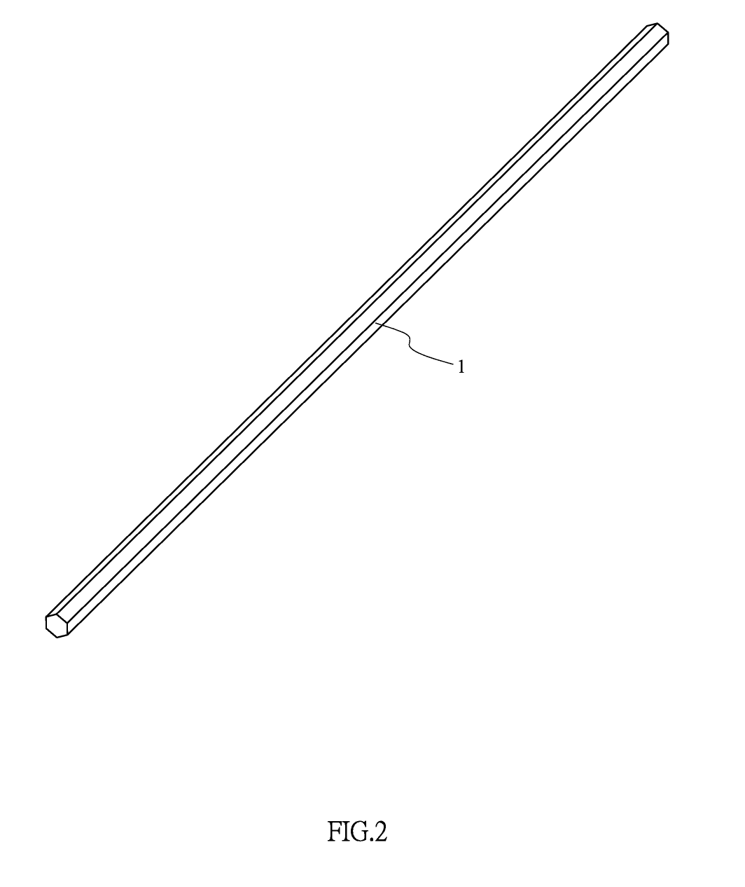

FIG. 3 shows the third step of the conventional method for making the conventional folding tool;

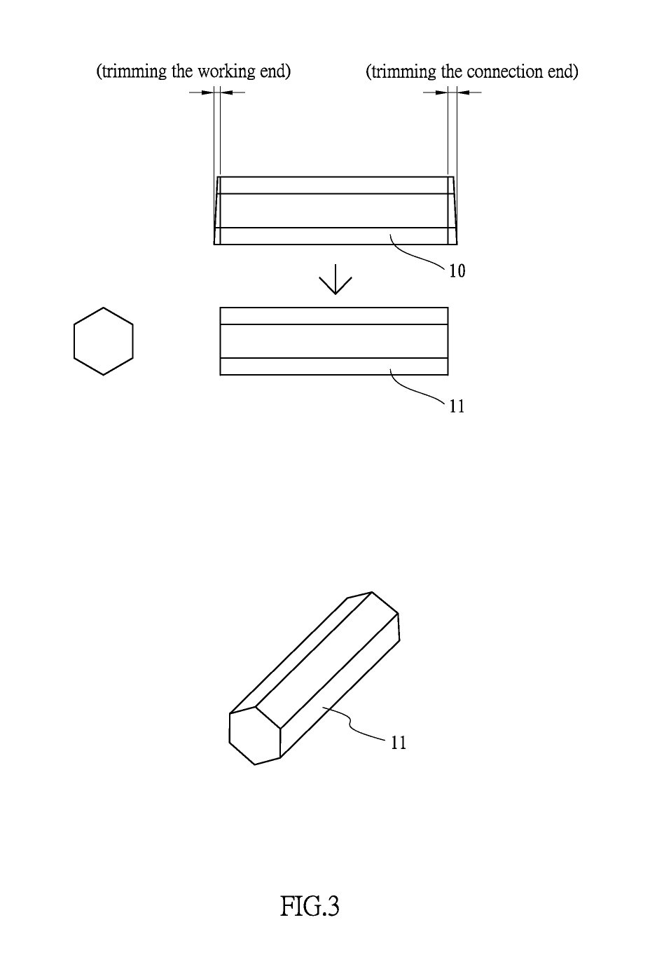

FIG. 4 shows the fourth step of the conventional method for making the conventional folding tool;

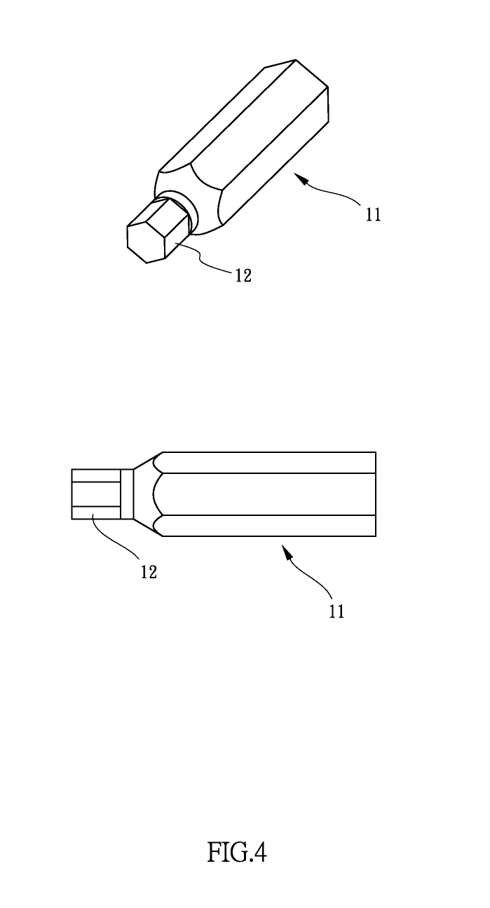

FIG. 5 shows the fifth step of the conventional method for making the conventional folding tool;

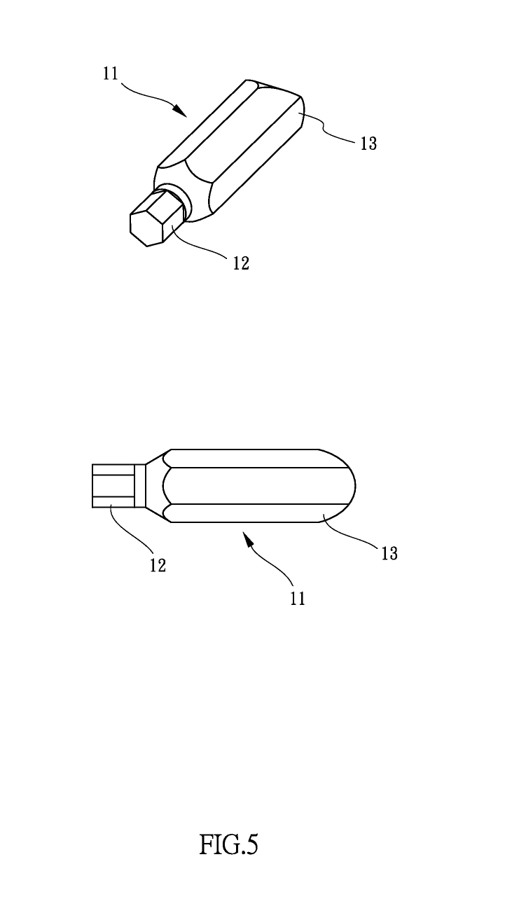

FIG. 6 shows the sixth step of the conventional method for making the conventional folding tool;

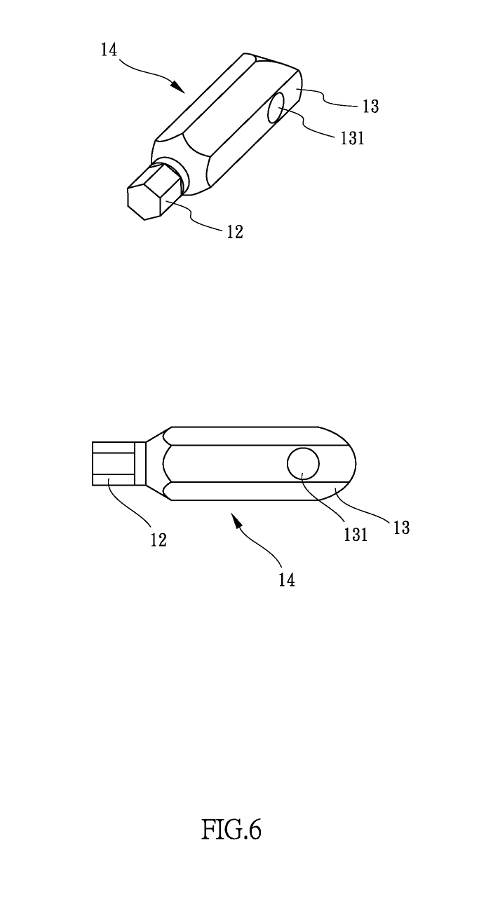

FIG. 7 shows the shortcoming of the second step of the conventional method for making the conventional folding tool;

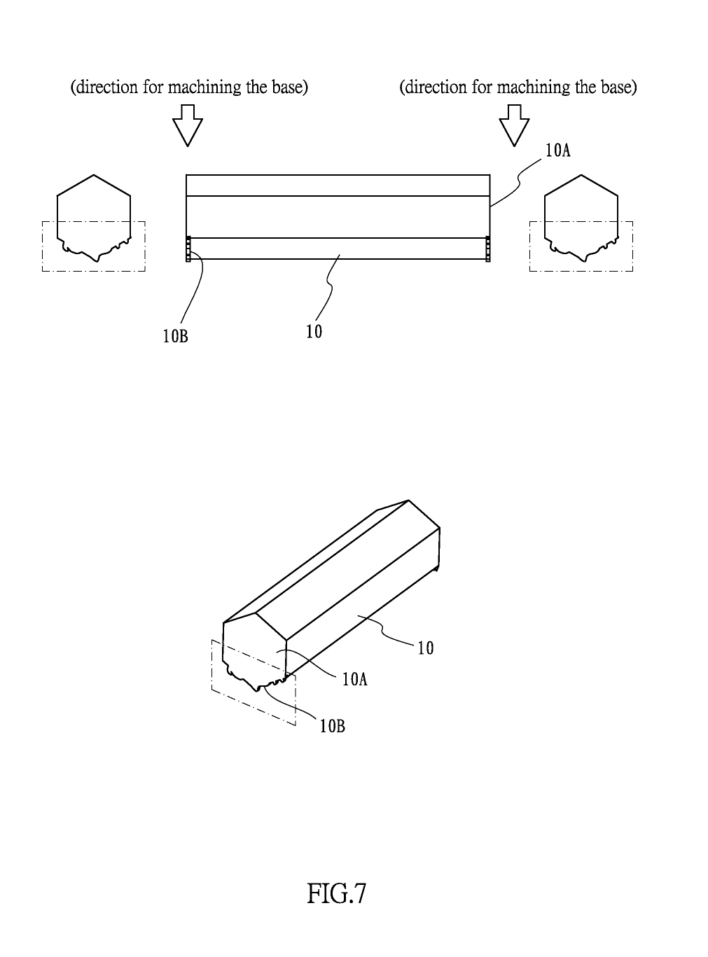

FIG. 8 shows the uneven portion formed on the underside of the base of the conventional method affects the clamping action;

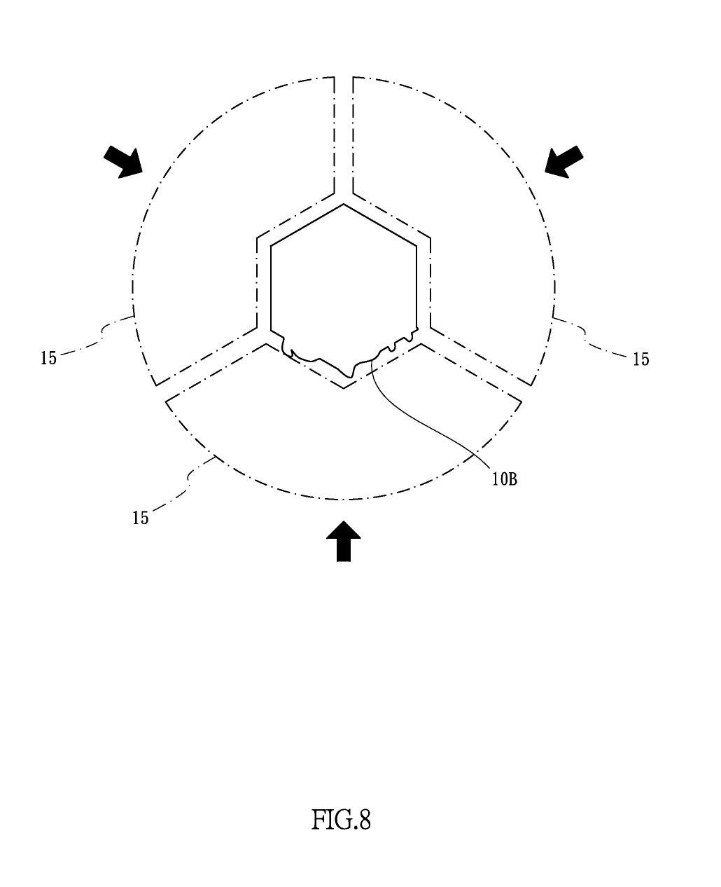

FIG. 9 shows that the end surfaces are not vertical in the second step of the conventional method;

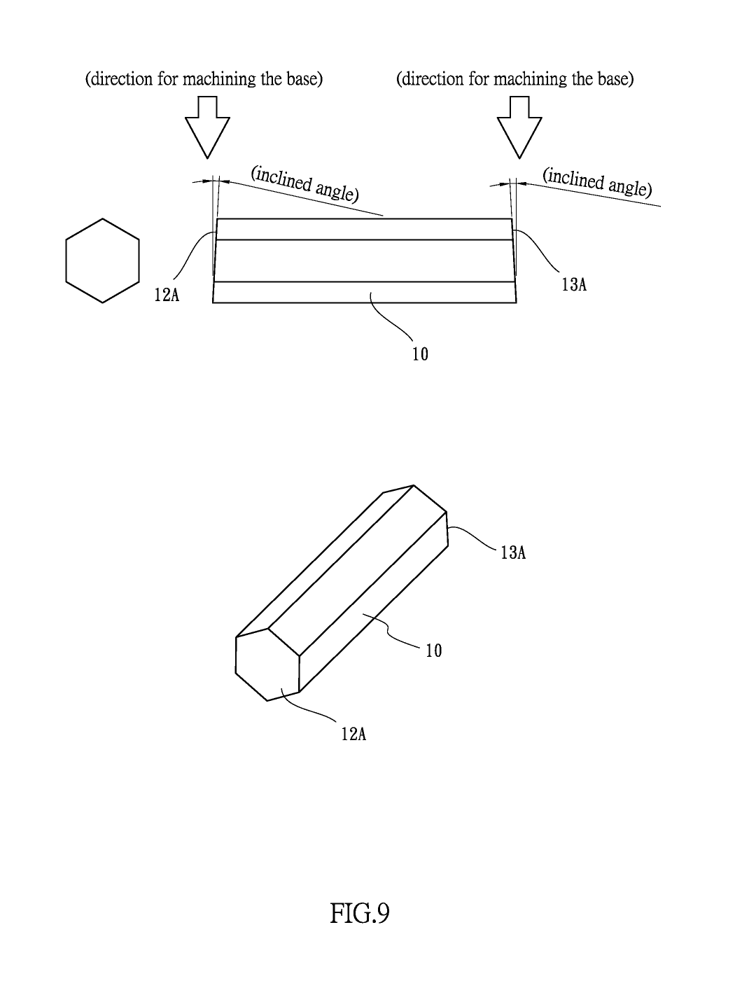

FIG. 10 shows the shortcoming of the sixth step of the conventional method;

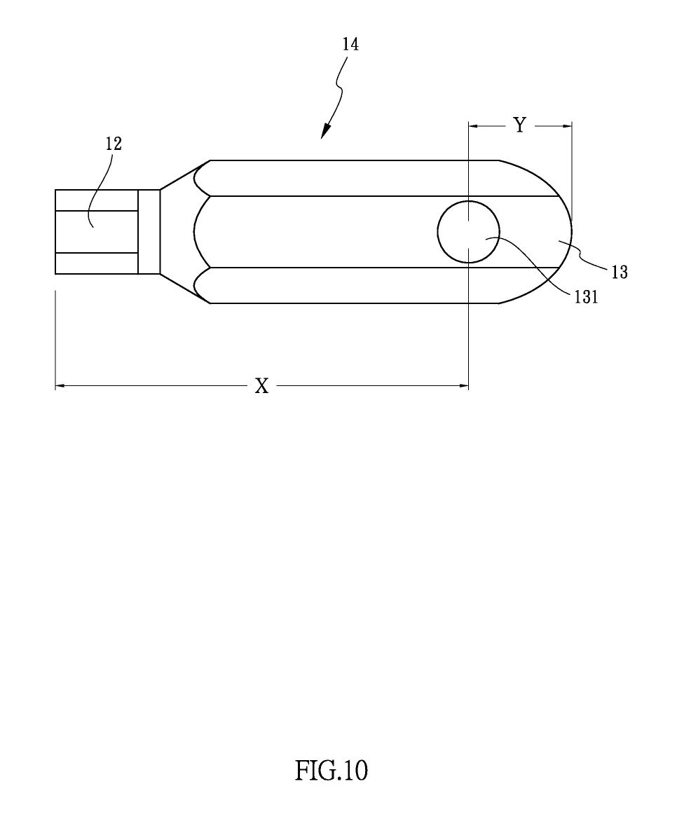

FIG. 11 shows the different lengths of the conventional folding tools at the working ends thereof;

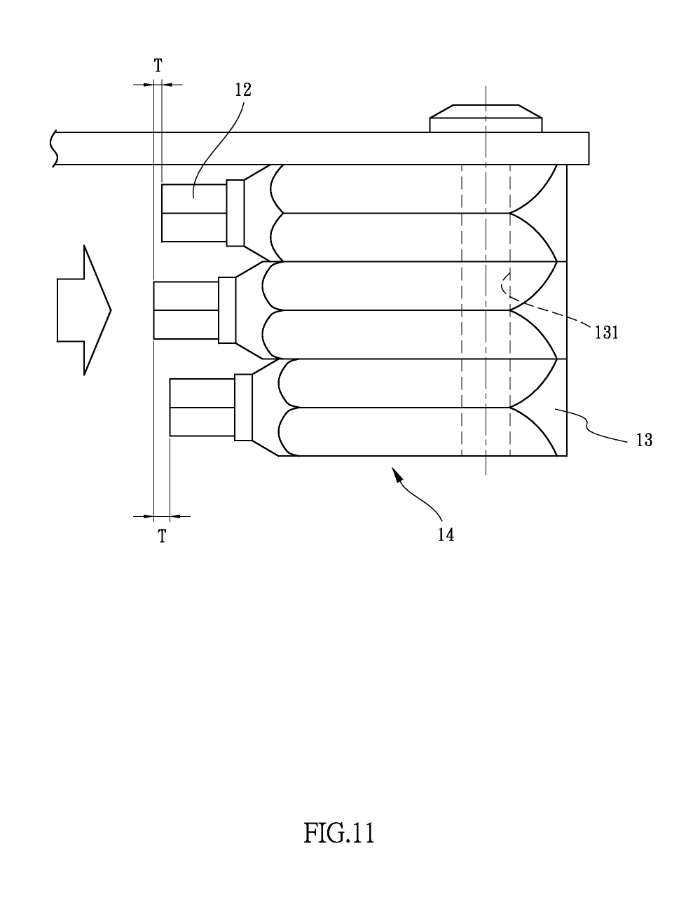

FIG. 12 shows the different lengths of the conventional folding tools at the connection ends thereof;

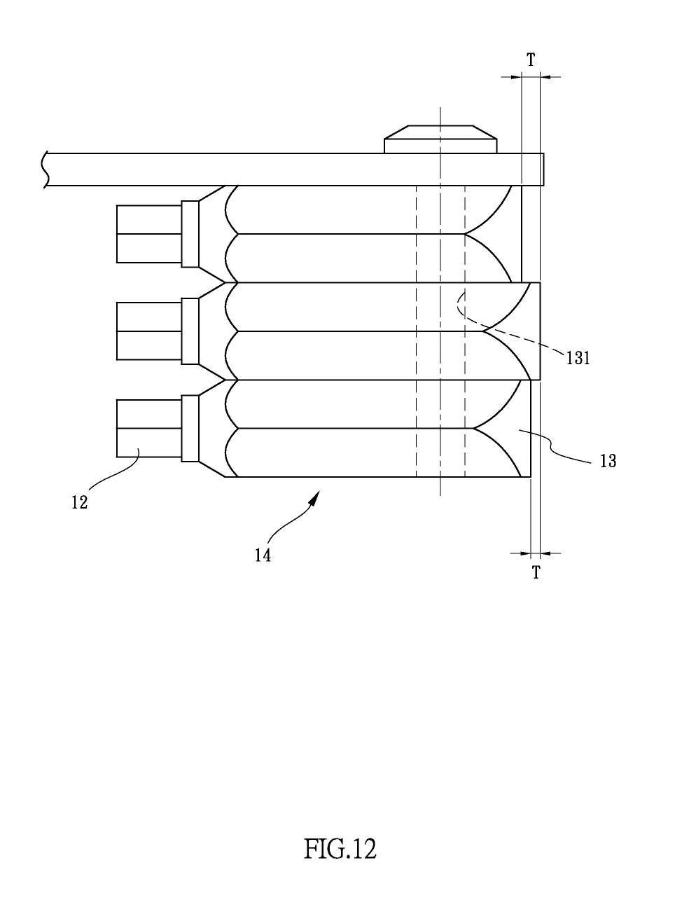

FIG. 13 shows the steps of the method of the present invention;

FIG. 14 shows the object of the first step of the method of the present invention;

FIG. 15 shows the object of the second step of the method of the present invention;

FIG. 16 shows the object of the third step of the method of the present invention;

FIG. 17 shows the object of the fourth step of the method of the present invention;

FIG. 18 shows that the folding tools made by the method of the present invention;

FIG. 19 shows the steps of the second embodiment of the method of the present invention, and

FIG. 20 shows the object in the second step of the second embodiment of the method of the present invention.

### DETAILED DESCRIPTION OF THE PREFERRED EMBODIMENT

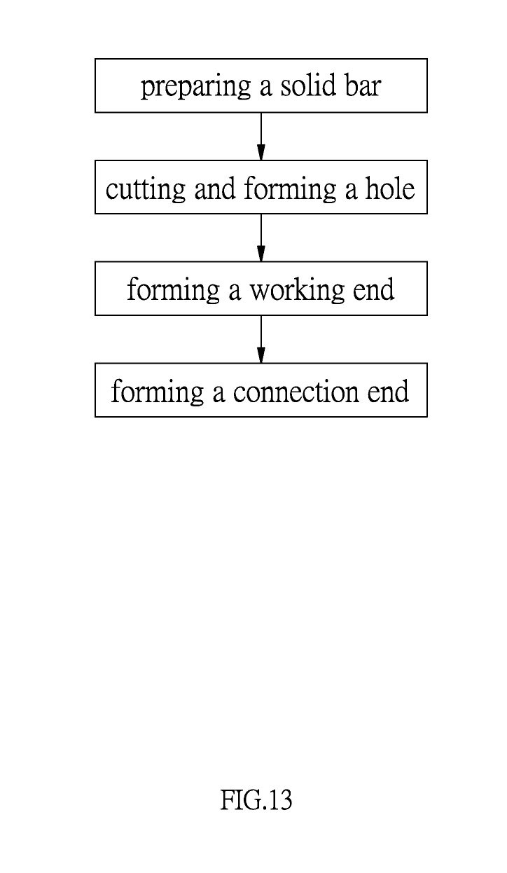

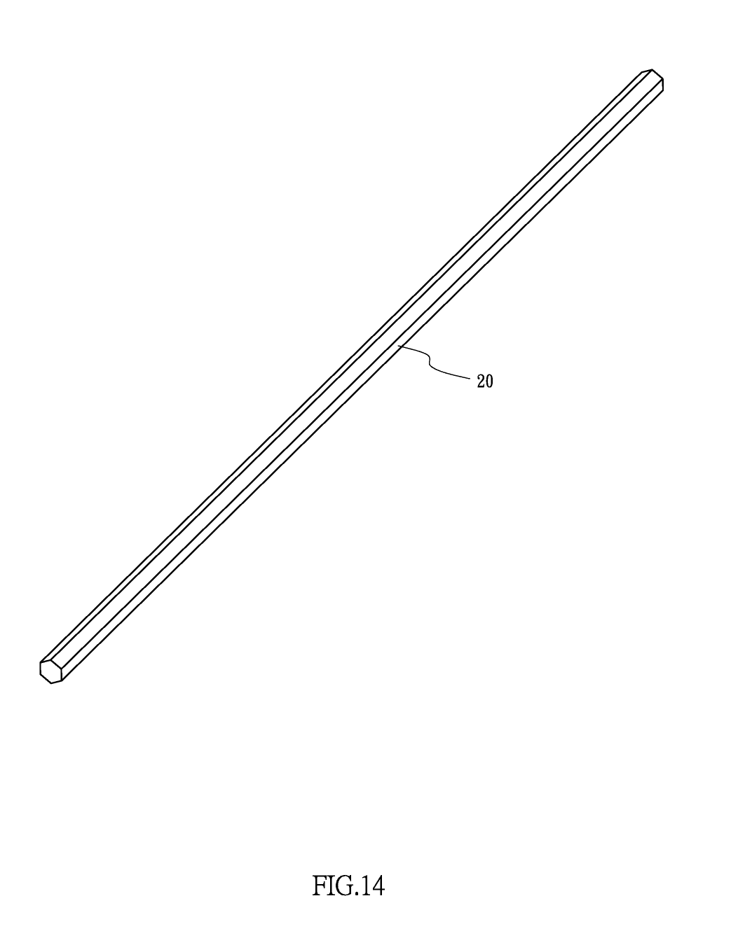

Referring to FIG. 13, the method of the present invention comprises a step of preparing: preparing a solid bar 20 which has a hexagonal cross section, a rectangular cross section or a circular cross section as shown in FIG. 14;

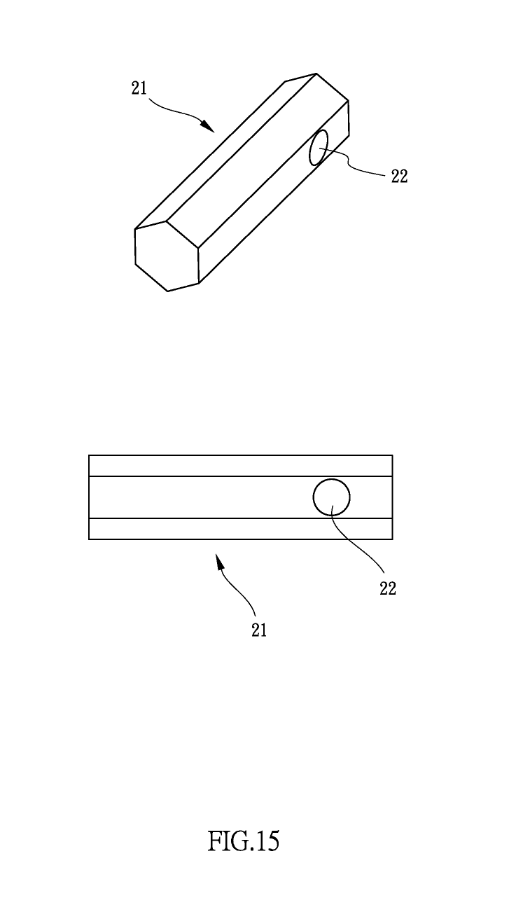

a step of cutting and forming a hole: cutting the bar 20 into sections of pre-set length to form a semi-finished tool 21 as shown in FIG. 15, a hole 22 being simultaneously formed in one end of the section;

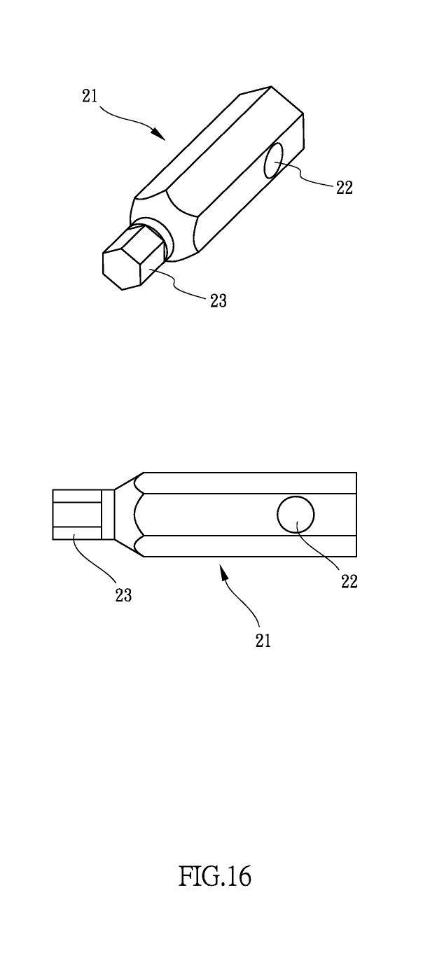

a step of forming a working end: forming a working end 23 to the semi-finished product 21 by peeling and milling as shown in FIG. 16, and

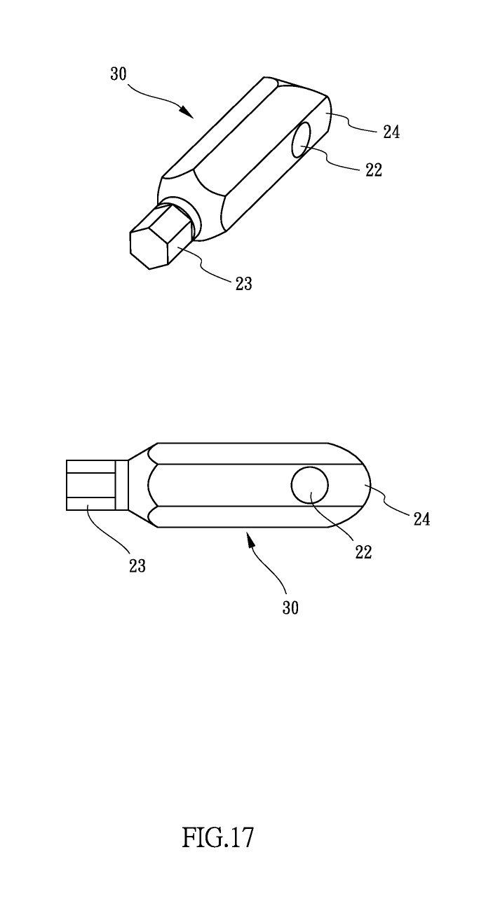

a step of forming a connection end: forming a connection end 24 with the hole 22 located at the center of the connection end 24 to form a folding tool 30 as shown in FIG. 17.

In the step of cutting and forming a hole, the cutting action makes the end surfaces of the bar 20 into flat surfaces so that no extra trimming action is needed to remove any possible surplus material. This saves manufacturing cost and labor.

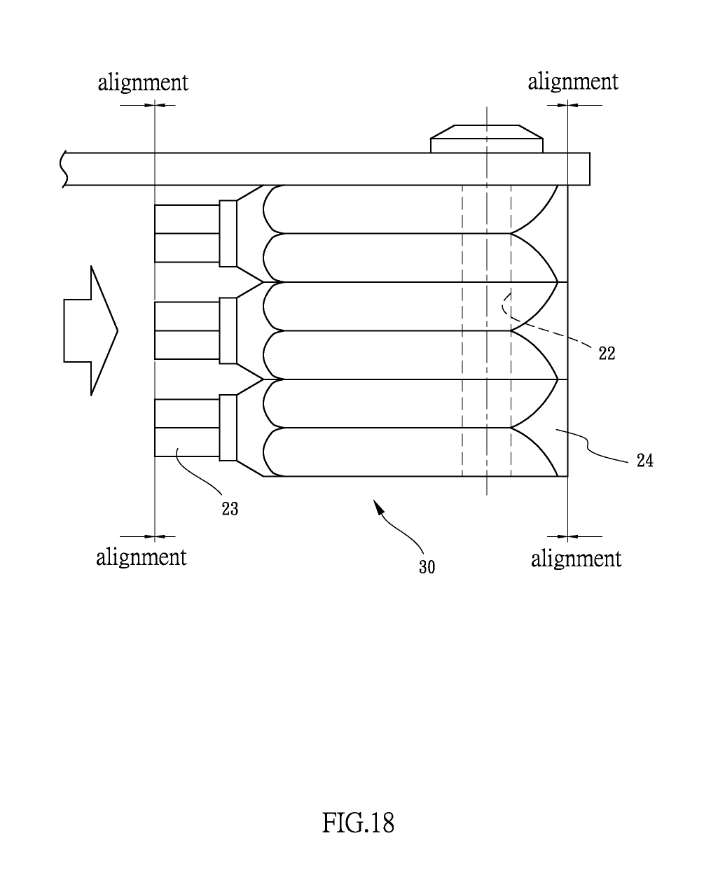

The hole 22 is formed simultaneously in the step of cutting and forming a hole so that the connection end 24 is formed with the hole 22 located at the center of the connection end 24. The tolerance between the hole 22 and the working end 23 is minimized. Therefore, the size of the folding tools 30 is identical as shown in FIG. 18.

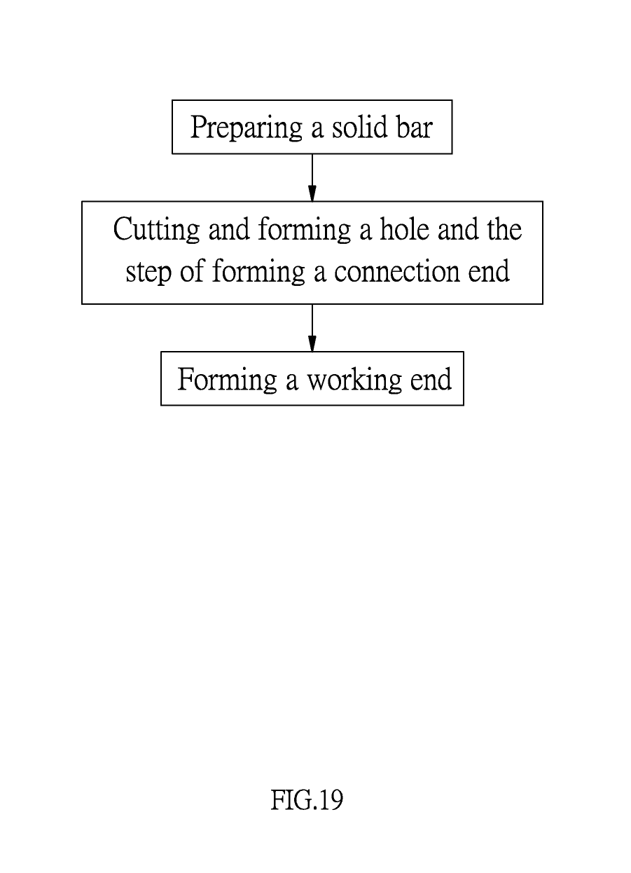

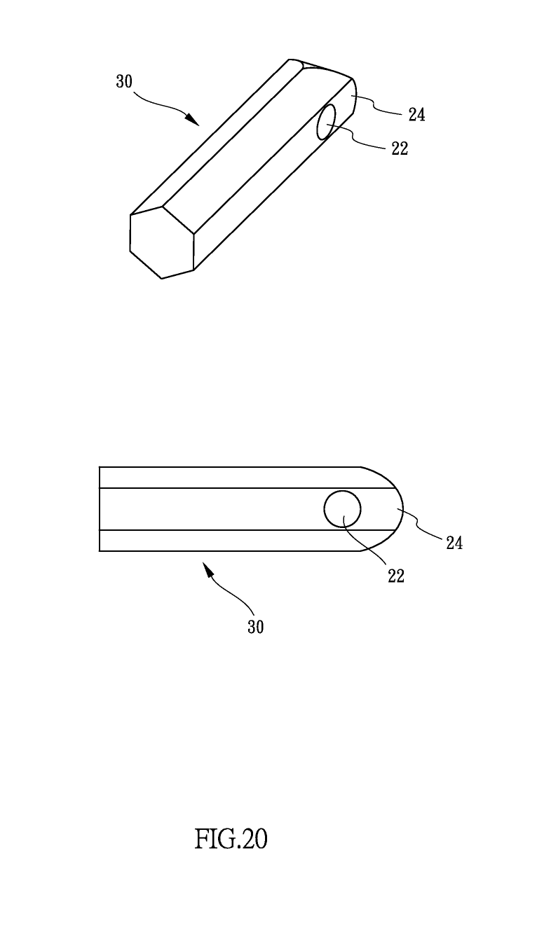

As shown in FIGS. 19 and 20, the step of cutting and forming a hole and the step of forming a connection end are operated simultaneously. This method can ensure that the hole 22 is located at the center of the connection end 24, so that the holes 22 of the folding tools 30 are precisely located. The length of all of the folding tools 30 is the same. Also, the manufacturers do not need to predict the length for the connection end 24, so that the use of material is well controlled.

While we have shown and described the embodiment in accordance with the present invention, it should be clear to those skilled in the art that further embodiments may be made without departing from the scope of the present invention.

What is claimed is:

1. A method for making a bicycle folding tool, comprising:
a step of preparing: preparing a solid bar which has a hexagonal cross section, a rectangular cross section or a circular cross section;
a step of cutting and forming a hole: cutting the bar into sections of pre-set length to form a semi-finished tool, a hole being simultaneously formed in one end of the section;
a step of forming a working end: forming a working end to the semi-finished product by peeling and milling, and
a step of forming a connection end: forming a connection end with the hole located at a center of the connection end to form a folding tool.

2. The method as claimed in claim 1, wherein the step of cutting and forming a hole and the step of forming a connection end are operated simultaneously.
